(19) United States
(12) Patent Application Publication
(10) Pub. No.: US 2025/0034327 A1
(43) Pub. Date: Jan. 30, 2025

(54) POLYESTER RESIN AND MOLDED PRODUCT INCLUDING THE SAME

(71) Applicant: FUJIFILM Corporation, Tokyo (JP)

(72) Inventors: Shohei KATAOKA, Kanagawa (JP); Shinsuke Tokuoka, Kanagawa (JP)

(73) Assignee: FUJIFILM Corporation, Tokyo (JP)

(21) Appl. No.: 18/733,793

(22) Filed: Jun. 4, 2024

(30) Foreign Application Priority Data
Jul. 28, 2023 (JP) 2023-123518

(51) Int. Cl. C08G 63/183

(52) U.S. Cl. CPC C08G 63/183

(57) ABSTRACT

Provided are a polyester resin that achieves both a high Tg and low water absorbency at an excellent level; and a molded product including the same.

A polyester resin including a structural unit represented by General Formula (A) and at least one of a structural unit represented by General Formula (B) or a structural unit represented by General Formula (C); and a molded product including the same.

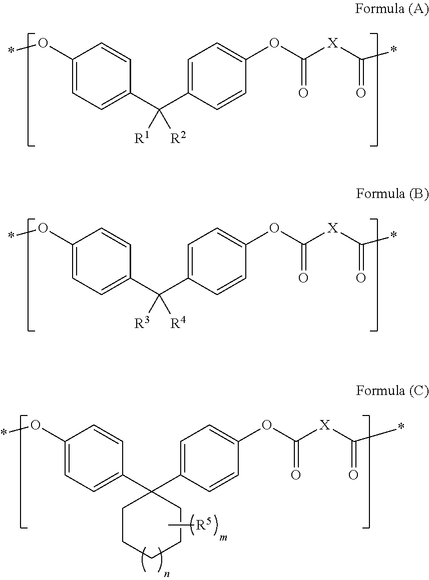

In the formula, R¹ represents a linear aliphatic hydrocarbon group having 6 or more carbon atoms, R² represents a hydrogen atom or a substituent, R³ represents a branched alkyl group having 3 or more carbon atoms, R⁴ represents a hydrogen atom or an aliphatic hydrocarbon group having 1 to 5 carbon atoms, R⁵ represents an aliphatic hydrocarbon group and X represents a hydrocarbon group having a cyclic structure. n is an integer of 0 to 8, m is an integer of 1 to 4, and It should be noted that R¹ and R² are not bonded to each other to form a ring, and R³ and R⁴ are not bonded to each other to form a ring. * represents a bonding site.

The 1,4-phenylene group in the formulae may be substituted with an aliphatic hydrocarbon group and/or an aromatic hydrocarbon group.

### CROSS-REFERENCE TO RELATED APPLICATIONS

This application claims priority under 35 U.S.C. § 119 (a) to Japanese Patent Application No. 2023-123518 filed in Japan on Jul. 28, 2023. Each of the above applications is hereby expressly incorporated by reference, in its entirety, into the present application.

### BACKGROUND OF THE INVENTION

### 1. Field of the Invention

The present invention relates to a polyester resin and a molded product including the same.

### 2. Description of the Related Art

The polyester resin is widely used in various fields such as synthetic fibers, films, PET bottles, mechanical components, automobile components, containers, and electronic materials since the polyester resin is excellent in heat resistance, mechanical strength, low water absorbency, and the like.

In accordance with these applications, research on a polyester having a specific chemical structure has been repeated.

For example, WO2022/239656A discloses a polyester which contains a total content of 10% by mass or more of at least one of a structural unit derived from a bisphenol having a branched alkyl group having 4 or more carbon atoms or a structural unit derived from a linear alkyl group having 3 to 21 carbon atoms, and contains 10% by mass or more of a structural unit derived from a dicarboxylic acid having a biphenyl structure.

JP2003-029447A describes a polyester resin including a structure derived from an ortho-substituted bisphenol compound, and a method for producing a charge transport layer in an electrophotographic photoreceptor, using the polyester resin as a binder resin.

### SUMMARY OF THE INVENTION

Examples of a use of the polyester resin include the use in an electrical insulating material utilizing heat resistance and low water absorbency. However, according to the studies of the present inventors, it was found that polyester resins in the related art, such as the polyester resin described in WO2022/239656A or JP2003-029447A, have not reached realization of achieving both a high glass transition temperature (hereinafter also referred to as a “Tg”) and low water absorbency at a high level.

That is, Examples of WO2022/239656A show that a cast film formed of a polyester, in which the polyester contains one of a structural unit derived from a bisphenol having a branched alkyl group having 4 or more carbon atoms, or a structural unit derived from a bisphenol having a linear alkyl group having 3 to 21 carbon atoms, and a structural unit derived from a dicarboxylic acid, having a biphenyl structure, at a specific content ratio has excellent abrasion resistance, and excellent film-forming properties even in a case where a large amount of functional materials coexist, due to the polyester. In other words, for the polyester described in WO2022/239656A, only a form in which one of a structural unit derived from a bisphenol having a branched alkyl group having 4 or more carbon atoms, or a structural unit derived from a bisphenol having a linear alkyl group having 3 to 21 carbon atoms is described, and as a result, it is not realized to achieve both a high Tg and low water absorbency at a high level.

In addition, JP2003-029447A does not describe the characteristics such as a high Tg and low water absorbency, and the polyester having a structural unit derived from a bisphenol having a branched alkyl group, described in Examples of JP2003-029447A, has not reached achieving both the high Tg and the low water absorbency at a desired high level. That is, the polyester described in Examples 8 and 11 of JP2003-029447A is a polyester having a structural unit derived from a bisphenol component having a branched alkyl group and a bis(4-hydroxy-3,5-dimethylphenyl) methane component not contributing to low water absorbency, and is further inferior in low water absorbency to a polyester having only a bisphenol having a branched alkyl group as the bisphenol component (see Polyester c2 described in Examples which will be described later).

An object of the present invention is to provide a polyester resin having both of a high Tg (120° C. or higher) and low water absorbency (less than 0.30% by mass of a water absorption rate); and a molded product including the same.

The object of the present invention have been accomplished by the following means.

<1>

A polyester resin comprising:
a structural unit represented by General Formula (A); and
at least one of a structural unit represented by General Formula (B) or a structural unit represented by General Formula (C).

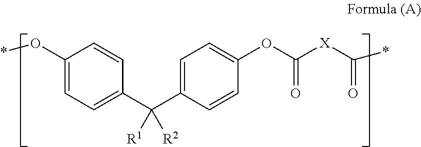

In the formula, R¹ represents a linear aliphatic hydrocarbon group having 6 or more carbon atoms, and R² represents a hydrogen atom, an aliphatic hydrocarbon group, or an aromatic hydrocarbon group, provided that R¹ and R² are not bonded to each other to form a ring.

X represents a hydrocarbon group having a cyclic structure.

* represents a bonding site.

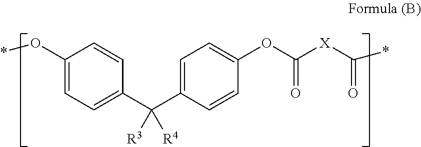

In the formula, R³ represents a branched alkyl group having 3 or more carbon atoms, and R⁴ represents a hydrogen atom or an aliphatic hydrocarbon group having 1 to 5 carbon atoms, provided that R³ and R⁴ are not bonded to each other to form a ring.

X represents a hydrocarbon group having a cyclic structure.

* represents a bonding site.

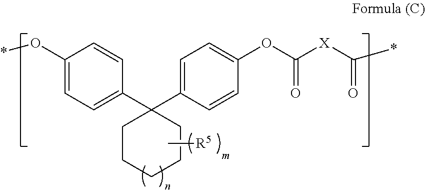

In the formula, R′ represents an aliphatic hydrocarbon group and X represents a hydrocarbon group having a cyclic structure.

n is an integer of 0 to 8 and m is an integer of 1 to 4.

* represents a bonding site.

The 1,4-phenylene group in General Formulae (A) to (C) may have an aliphatic hydrocarbon group and/or an aromatic hydrocarbon group as a substituent.

2>

The polyester resin according to <1>,
in which X is an arylene group.

<3>

The polyester resin according to <1> or <2>,
in which the polyester resin contains at least the structural unit represented by General Formula (A) and the structural unit represented by General Formula (B).

<4>

A molded product comprising:
the polyester resin according to any one of <1> to <3>.

In the present invention, in a case where there are a plurality of substituents, linking groups, and the like (hereinafter referred to as a substituent and the like) represented by a specific reference or formula, or in a case where a plurality of the substituent and the like are simultaneously defined, the substituents and the like may be the same as or different from each other (regardless of the presence or absence of an expression “each independently”, the substituents and the like may be the same as or different from each other) unless otherwise specified. The same also applies to the definitions of the number of substituents and the like. Moreover, in the present invention, in a case where there are a plurality of structural units represented by a specific formula, the plurality of structural units may be the same as or different from each other (regardless of whether or not the expression “each independently” is used, the plurality of structural units may be the same as or different from each other) unless otherwise specified. In addition, in a case where a plurality of substituents or the like are close to each other (particularly in a case where the substituents are adjacent to each other), the substituent may be linked to each other to form a rings unless otherwise specified. Furthermore, rings such as an alicyclic ring, an aromatic ring, and a heterocyclic ring may be fused to form a fused ring unless otherwise specified.

In the present invention, in a case where a molecule has an E-type double bond and a Z-type double bond, the molecule may be either an E isomer or a Z isomer, or may be a mixture thereof unless otherwise specified.

In addition, in the present invention, in case where a compound has one or two or more asymmetric carbons, either the (R) isomer or the(S) isomer can be independently employed for the stereochemistry of asymmetric carbons unless otherwise specified. As a result, the compound may be a mixture of optical isomers or stereoisomers such as diastereoisomers, or may be racemic.

In addition, in the present invention, the expression of the compound means that a compound having a partially changed structure is included within a range which does not impair the effects of the present invention. Furthermore, a compound which is not specifically described as substituted or unsubstituted may have an optional substituent within a range which does not impair the effects of the present invention.

In the present invention, in a case where the number of carbon atoms of a certain group is specified, this number of carbon atoms means the number of carbon atoms in the entire group thereof unless otherwise specified in the present invention or the present specification.

In the present invention, numerical ranges represented by “to” include numerical values before and after “to” as lower limit values and upper limit values.

In the present invention, an aliphatic hydrocarbon group is a monovalent group obtained by removing any one hydrogen atom from the aliphatic hydrocarbon. The monovalent group is preferably a monovalent group obtained by removing any one hydrogen atom from an alkane, an alkene, an alkyne, a cycloalkane, a cycloalkene, or a cycloalkyne which is an aliphatic hydrocarbon. The aliphatic hydrocarbon group may be linear or branched, and may have a ring structure.

That is, preferred examples of the aliphatic hydrocarbon group include an alkyl group, an alkenyl group, an alkynyl group, a cycloalkyl group, a cycloalkenyl group, and a cycloalkynyl group.

The linear aliphatic hydrocarbon group is a group obtained by removing one hydrogen atom from a terminal carbon atom of a linear aliphatic hydrocarbon. Preferred examples of the linear aliphatic hydrocarbon group include a linear alkyl group, a linear alkenyl group, and a linear alkynyl group.

In the present invention, the number of carbon atoms in the alkyl group is preferably 1 to 24, more preferably 1 to 19, still more preferably 1 to 15, and particularly preferably 1 to 11.

Examples of the linear alkyl group include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, an n-octadecyl group, an n-nonadecyl group, an n-eicosyl group, an n-heneicosyl group, an n-docosyl group, an n-tricosyl group, and an n-tetracosyl group.

Examples of the branched alkyl group include a methylethyl group, a methylpropyl group, a methylbutyl group, a methylpentyl group, a methylhexyl group, a methylheptyl group, a methyloctyl group, a methylnonyl group, a methyldecyl group, a methylundecyl group, a methyldodecyl group, a methyltridecyl group, a methyltetradecyl group, a methylpentadecyl group, a methylhexadecyl group, a methylheptadecyl group, a methyloctadecyl group, a methylnonadecyl group, a methylicosyl group, a methylhenicosyl group, a methyldocosyl group, a methyltricosyl group,
a dimethylethyl group, a dimethylpropyl group, a dimethylbutyl group, a dimethylpentyl group, a dimethylhexyl group, a dimethylheptyl group, a dimethyloctyl group, a dimethylnonyl group, a dimethyldecyl group, a dimethylundecyl group, a dimethyldodecyl group, a dimethyltridecyl group, a dimethyltetradecyl group, a dimethylpentadecyl group, a dimethylhexadecyl group, a dimethylheptadecyl group, a dimethyloctadecyl group, a dimethylnonadecyl group, a dimethylicosyl group, a dimethylhenicosyl group, a dimethyldocosyl group,
a trimethylethyl group, a trimethylpropyl group, a trimethylbutyl group, a trimethylpentyl group, a trimethylhexyl group, a trimethylheptyl group, a trimethyloctyl group, a trimethylnonyl group, a trimethyldecyl group, a trimethylundecyl group, a trimethyldodecyl group, a trimethyltridecyl group, a trimethyltetradecyl group, a trimethylpentadecyl group, a trimethylhexadecyl group, a trimethylheptadecyl group, a trimethyloctadecyl group, a trimethylnonadecyl group, a trimethylicosyl group, a trimethylheneicosyl group,
an ethylethyl group, an ethylpropyl group, an ethylbutyl group, an ethylpentyl group, an ethylhexyl group, an ethylheptyl group, an ethyloctyl group, an ethylnonyl group, an ethyldecyl group, an ethylundecyl group, an ethyldodecyl group, an ethyltridecyl group, an ethyltetradecyl group, an ethylpentadecyl group, an ethylhexadecyl group, an ethylheptadecyl group, an ethyloctadecyl group, an ethylnonadecyl group, an ethylicosyl group, an ethylhenicosyl group, an ethyldocosyl group,
a propylpropyl group, a propylbutyl group, a propylpentyl group, a propylhexyl group, a propylheptyl group, a propyloctyl group, a propylnonyl group, a propyldecyl group, a propylundecyl group, a propyldodecyl group, a propyltridecyl group, a propyltetradecyl group, a propylpentadecyl group, a propylhexadecyl group, a propylheptadecyl group, a propyloctadecyl group, a propylnonadecyl group, a propylicosyl group, a propylphenicosyl group, a butylbutyl group, a butylpentyl group, a butylhexyl group, a butylheptyl group, a butyloctyl group, a butylnonyl group, a butyldecyl group, a butylundecyl group, a butyldodecyl group, a butyltridecyl group, a butyltetradecyl group, a butylpentadecyl group, a butylhexadecyl group, a butylheptadecyl group, a butyloctadecyl group, a butylnonadecyl group, a butylicosyl group, and a butylphenicosyl group.

Incidentally, in the examples of the branched alkyl group, the branch can be present at any position.

In the present invention, the number of carbon atoms in the alkenyl group is preferably 2 to 24, more preferably 2 to 19, still more preferably 2 to 15, and particularly preferably 2 to 11.

Examples of the alkenyl group include a vinyl group, a propenyl group, a butenyl group, a pentenyl group, a hexenyl group, a heptenyl group, an octenyl group, a nonenyl group, a decenyl group, an undecenyl group, a dodecenyl group, a tridecenyl group, a tetradecenyl group, a pentadecenyl group, a hexadecenyl group, a heptadecenyl group, an octadecenyl group, a nonadecenyl group, an icosanyl group, a henicosanyl group, a docosanyl group, a tricosanyl group, a tetracosanyl group, and a 4,8,12-trimethyltridecyl group.

In the present invention, the number of carbon atoms in the alkynyl group is preferably 2 to 24, more preferably 2 to 19, still more preferably 2 to 15, and particularly preferably 2 to 11.

Examples of the alkynyl group include an ethynyl group and a propynyl group.

In the present invention, the cycloalkyl group is a monovalent group obtained by removing any one hydrogen atom from a cycloalkane. As the cycloalkyl group, a cycloalkyl group having 3 to 24 carbon atoms is preferable, and examples thereof include a cyclobutyl group, a cyclopentyl group, and a cyclohexyl group.

In the present invention, the cycloalkenyl group is a monovalent group obtained by removing any one hydrogen atom from a cycloalkene. As the cycloalkenyl group, a cycloalkenyl group having 5 to 24 carbon atoms is preferable, and examples thereof include a cyclopentenyl group and a cyclohexenyl group.

In the present invention, the cycloalkynyl group is a monovalent group obtained by removing any one hydrogen atom from a cycloalkyne. As the cycloalkynyl group, a cycloalkynyl group having 8 to 24 carbon atoms is preferable, and examples thereof include a cyclooctynyl group.

In the present invention, the aromatic hydrocarbon group is a monovalent group obtained by removing any one hydrogen atom from an aromatic hydrocarbon. The number of carbon atoms in the aromatic hydrocarbon group is preferably 6 to 24, more preferably 6 to 20, and still more preferably 6 to 14. Examples of the aromatic hydrocarbon group include a phenyl group, a 1-naphthyl groups, a 2-naphthyl groups, a 1-anthracenyl group, a 2-anthracenyl group, a 9-anthracenyl group, a 1-phenanthryl group, a 2-phenanthryl group, a 3-phenanthryl group, a 4-phenanthryl group, and a 9-phenanthryl group. Among the examples, the phenyl group is preferable.

The polyester resin of an embodiment of the present invention can achieve both a high Tg and low water absorbency at an excellent level. In addition, the molded product of an embodiment of the present invention includes the polyester resin, and has low water absorbency and excellent heat resistance.

### DESCRIPTION OF THE PREFERRED EMBODIMENTS

### Polyester Resin

The polyester resin of the embodiment of the present invention is a polyester resin containing a structural unit represented by General Formula (A) (structural unit (A)), and at least one of a structural unit represented by General Formula (B) (structural unit (B)) or a structural unit represented by General Formula (C) (structural unit (C)). The polyester resin of the embodiment of the present invention, which has such a configuration, can achieve a high Tg and low water absorbency at a desired high level. A reason thereof is not clear, but is assumed as follows.

The structural unit (A) having a linear aliphatic hydrocarbon group having 6 or more carbon atoms in the polyester resin of the embodiment of the present invention contributes to excellent low water absorbency, whereas it causes a decrease in Tg. By configuring the polyester resin of the embodiment of the present invention to contain at least one of the structural unit (B) having a branched alkyl group having 3 or more carbon atoms or the structural unit (C) having a branched structure (substituent R⁵) on a 5- to 13-membered (5+n-membered, where n is an integer of 0 to 8) ring in addition to the structural unit (A), the Tg can be increased while a decrease in low water absorbency due to the structural unit (A) is suppressed. In particular, with regard to the water absorbency, a water absorption rate (calculated value) is calculated by multiplying a content ratio of each structural unit by a water absorption rate exhibited by each structural unit of the structural units (A), (B), and (C), and a sum of the calculated values can be set to be lower than the measured value, making it possible to realize sufficient low water absorbency while maintaining the Tg as the polyester resin at a high level.

The polyester resin of the embodiment of the present invention can be suitably used as, for example, a low dielectric material due to the low water absorbency thereof.

Furthermore, the polyester resin of the embodiment of the present invention may be composed of a polyester containing the structural unit (A), and at least one of the structural unit (B) or the structural unit (C) (hereinafter referred to as “the polyester of the embodiment of the present invention”), or may be in the form of a composition in which an additive described later is blended with the polyester of the embodiment of the present invention.

Hereinafter, the polyester of the embodiment of the present invention will be described in detail.

### Polyester

### Structural Unit (A)

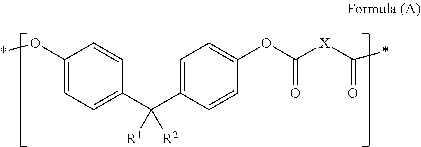

In the formula, R¹ represents a linear aliphatic hydrocarbon group having 6 or more carbon atoms, and R² represents a hydrogen atom, an aliphatic hydrocarbon group, or an aromatic hydrocarbon group, provided that R¹ and R² are not bonded to each other to form a ring.

X represents a hydrocarbon group having a cyclic structure.

* represents a bonding site.

The linear aliphatic hydrocarbon group having 6 or more carbon atoms as R¹ is not particularly limited as long as it has 6 or more carbon atoms, and the description of the linear aliphatic hydrocarbon group mentioned above can be applied thereto.

The number of carbon atoms in the linear aliphatic hydrocarbon group as R¹ is 6 or more, preferably 6 to 24, more preferably 6 to 22, still more preferably 6 to 18, and particularly preferably 6 to 16, and among these, the number of 6 to 14 is preferable.

R¹ is preferably a linear alkyl group, a linear alkenyl group, or a linear alkynyl group, each having 6 or more carbon atoms, more preferably the linear alkyl group or the linear alkenyl group, each having 6 or more carbon atoms, and still more preferably the linear alkyl group having 6 or more carbon atoms.

The aliphatic hydrocarbon group and the aromatic hydrocarbon group, which can be employed as R², are not particularly limited, and the description of the aliphatic hydrocarbon group and aromatic hydrocarbon group mentioned above can be applied thereto.

As the aliphatic hydrocarbon group which can be employed as R², an alkyl group, an alkenyl group, or an alkynyl group is preferable, the alkyl group or the alkenyl group is more preferable, and the alkyl group is still more preferable.

It is preferable that R² does not include a ring structure.

R² is preferably a hydrogen atom, an alkyl group, an alkenyl group, or an alkynyl group, more preferably the hydrogen atom or the alkyl group, still more preferably the hydrogen atom or an alkyl group having 1 to 6 carbon atoms, and particularly preferably the hydrogen atom, a methyl group, or an ethyl group.

Examples of the hydrocarbon group having a cyclic structure as X include an arylene group, and phenylene, and the hydrocarbon group is preferably naphthalene or anthracene, and more preferably phenylene.

### Structural Unit (B)

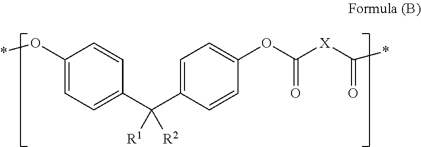

In the formula, R³ represents a branched alkyl group having 3 or more carbon atoms, and R⁴ represents a hydrogen atom or an aliphatic hydrocarbon group having 1 to 5 carbon atoms, provided that R³ and R⁴ are not bonded to each other to form a ring.

X represents a hydrocarbon group having a cyclic structure.

* represents a bonding site.

The branched alkyl group having 3 or more carbon atoms as R³ is not particularly limited as long as it has 3 or more carbon atoms, and the description of the branched alkyl group mentioned above can be applied thereto.

The number of carbon atoms in the branched alkyl group as R³ is 3 or more, preferably 3 to 11, more preferably 3 to 7, and still more preferably 3 to 5.

In the branched alkyl group as R³, the number of carbon atoms constituting the chain, as determined by counting from a carbon atom having a bonding site to which R⁴ is bonded, up to a carbon atom on the most terminal side (hereinafter referred to as “the number of carbon atoms constituting the longest chain of R³”) is preferably 7 or less, more preferably 5 or less, and still more preferably 3 or less. For example, in the structural unit derived from the bisphenol component (B-2) used in Examples, the number of carbon atoms constituting the longest chain of R³ is 3.

In addition, in the branched alkyl group as R³, the number of carbon atoms constituting the chain, as determined by counting from a carbon atom having a bonding site to which R⁴ is bonded, up to a carbon atom having a branched structure for the first time (hereinafter referred to as the “number of carbon atoms of R³ up to the branched structure”) is preferably 1 to 5, more preferably 1 to 3, and still more preferably 2 or 3. For example, in the structural unit derived from the bisphenol component (B-2) used in Examples, the number of carbon atoms to the branched structure of R³ is 2.

R³ is preferably a branched alkyl group, a branched alkenyl group, or a branched alkynyl group, each having 3 or more carbon atoms, more preferably the branched alkyl group or the branched alkenyl group, each having 3 or more carbon atoms, and still more preferably the branched alkyl group having 3 or more carbon atoms.

The aliphatic hydrocarbon group having 1 to 5 carbon atoms which can be employed as R⁴ is not particularly limited as long as it has 1 to 5 carbon atoms, and the description of the aliphatic hydrocarbon group mentioned above can be applied.

The number of carbon atoms in the aliphatic hydrocarbon group which can be employed as R⁴ is 1 to 5, and preferably 1 to 3.

The aliphatic hydrocarbon group having 1 to 5 carbon atoms which can be employed as R⁴ is preferably an alkyl group, an alkenyl group, or an alkynyl group, each having 1 to 5 carbon atoms, more preferably the alkyl group or the alkenyl group, each having 1 to 5 carbon atoms, and still more preferably the alkyl group having 1 to 5 carbon atoms.

R⁴ is preferably a hydrogen atom, or an alkyl group, an alkenyl group, or an alkynyl group, each having 1 to 5 carbon atoms, more preferably the hydrogen atom, or the alkyl group or the alkenyl group, each having 1 to 5 carbon atoms, and still more preferably the hydrogen atom or the alkyl group having 1 to 5 carbon atoms.

X has the same definition as X in the structural unit (A) described above.

### Structural Unit (C)

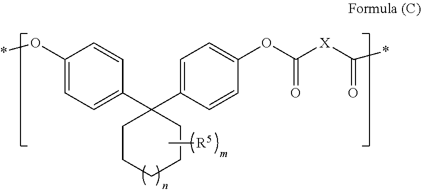

In the formula, R⁵ represents an aliphatic hydrocarbon group and X represents a hydrocarbon group having a cyclic structure.

n is an integer of 0 to 8 and m is an integer of 1 to 4.

* represents a bonding site.

The aliphatic hydrocarbon group as R⁵ is not particularly limited, and the description of the aliphatic hydrocarbon group mentioned above can be applied thereto.

As the aliphatic hydrocarbon group which can be employed as R⁵, an alkyl group or an alkenyl group is preferable, the alkyl group is more preferable, an alkyl group having 1 to 6 carbon atoms is still more preferable, and an alkyl group having 1 to 3 carbon atoms is particularly preferable.

In a case where a plurality of R⁵'s are present, the plurality of R⁵'s may be the same as or different from each other.

Incidentally, in a case where a plurality of R⁵'s are present, the plurality of R⁵'s may be bonded to each other to form a ring, but it is preferable that the plurality of R⁵'s do not form a ring.

n is an integer of 0 to 8, preferably an integer of 0 to 4, more preferably 0 or 1, and still more preferably 0.

m is an integer of 1 to 4, and preferably an integer of 1 to 3.

Any of the 1,4-phenylene groups shown in General Formulae (A) to (C) may have the above-described aliphatic hydrocarbon group and/or aromatic hydrocarbon group as a substituent. In the present invention, the structure in which the 1,4-phenylene group shown in General Formulae (A) to (C) has an aliphatic hydrocarbon group and/or an aromatic hydrocarbon group as a substituent is also intended to be included in the structural units represented by General Formulae (A) to (C).

The substituent which may be contained in the 1,4-phenylene group in General Formulae (A) to (C) is preferably the aliphatic hydrocarbon group.

Among those, it is preferable that the 1,4-phenylene group in General Formulae (A) to (C) does not have a substituent, that is, is an unsubstituted group.

Specific examples of the structural unit (A) include structural units consisting of a structure selected from (A) structures shown below and a structure selected from (X) structures shown below. Specific examples of the structural unit (B) include a structural unit consisting of a structure selected from (B) structures shown below and a structure selected from the (X) structures shown below. Specific examples of the structural unit (C) include a structural unit consisting of a structure selected from (C) structures shown below and a structure selected from the (X) structures shown below. Incidentally, * in the following structures represents a bonding site.

In addition, reference can also each be made to the structural units formed from specific examples of bisphenol compounds (a) to (c) which will be described later, and a dicarboxylic acid compound or a compound in which a carboxy group is activated.

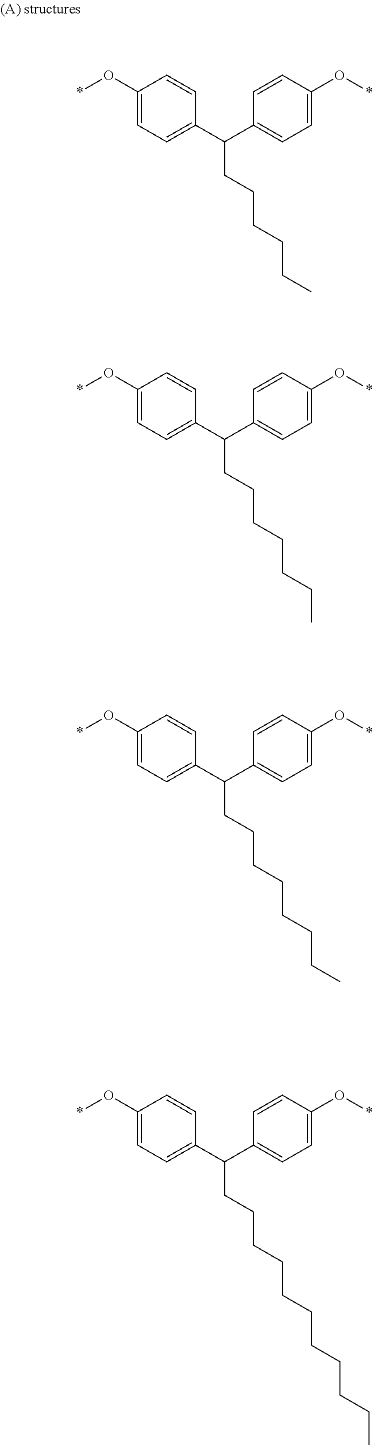

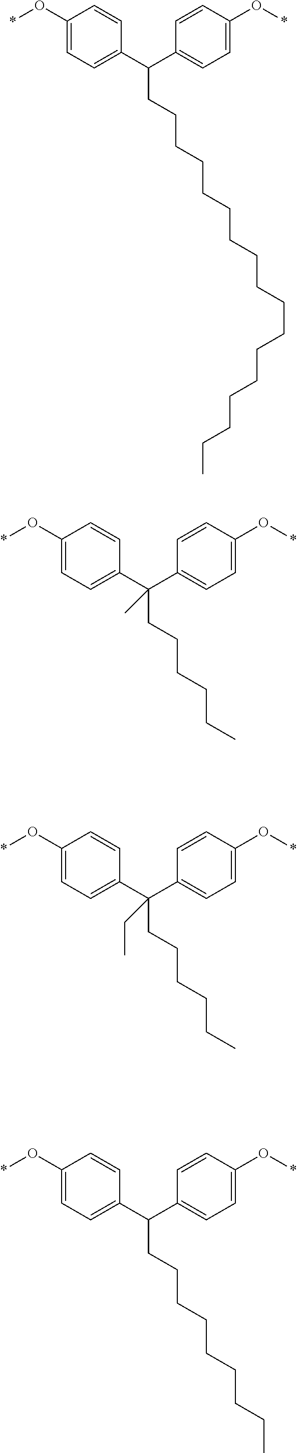

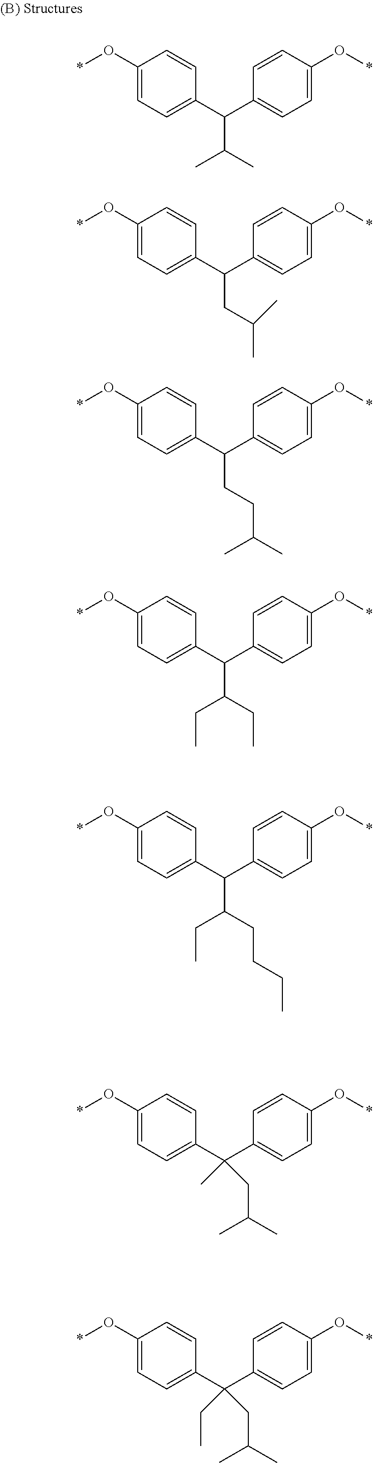

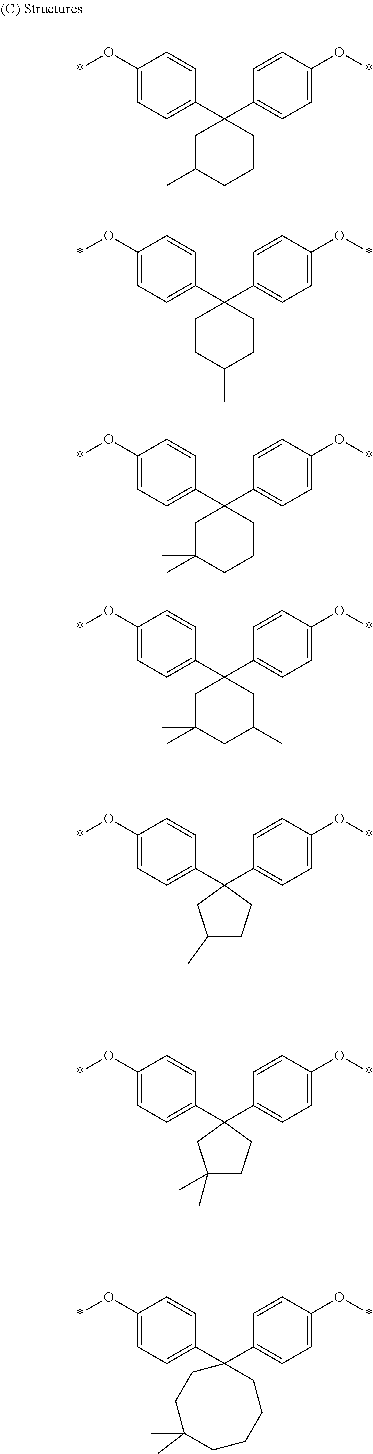

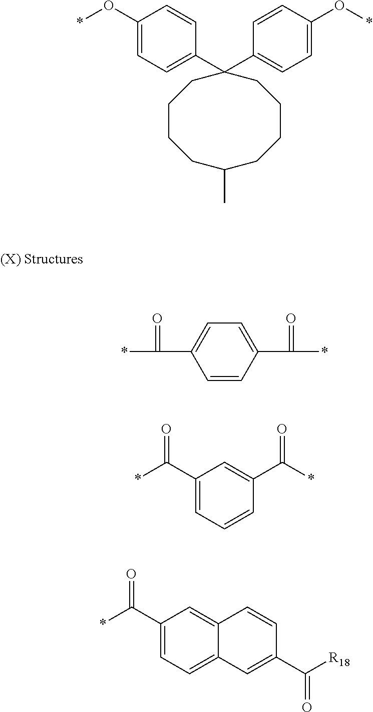

In the polyester resin of the embodiment of the present invention, it is preferable that the polyester of the embodiment of the present invention contains at least both structural units of the structural unit of the structural unit represented by General Formula (A) and the structural unit represented by General Formula (B) from the viewpoint of further enhancing the water absorbency while realizing a high Tg.

A proportion of the structural unit (A) in a total of 100% by mole of the structural units (A), (B), and (C) is preferably 15% to 60% by mole, and more preferably 20% to 40% by mole.

A proportion of the structural unit (B) in the total of 100% by mole of the structural units (A), (B), and (C) is preferably 25% to 85% by mole, and more preferably 50% to 80% by mole.

A proportion of the structural unit (C) in the total of 100% by mole of the structural units (A), (B), and (C) is preferably 15% to 60% by mole, and more preferably 30% to 60% by mole.

Furthermore, the structural unit (A) and the structural units (B) and (C) which may be included in the polyester of the embodiment of the present invention may each be of one kind or of two or more kinds.

In a case where two or more kinds of the structural units (A) are present in the polyester of the embodiment of the present invention, the proportion of the structural unit (A) means a total amount of the structural units (A). The same also applies to a case where two or more kinds of the structural units (B) are present and a case where two or more kinds of the structural units (C) are present.

### Other Structural Units

The polyester of the embodiment of the present invention may contain structural units other than the structural units (A), (B), and (C) (hereinafter referred to as “other structural units”).

Other structural units are not particularly limited as long as the effects of the present invention are exhibited, and examples thereof include an ester structural unit different from any of the structural units (A), (B), and (C). Specific examples of other structural units include a structural unit in which at least one of the structural unit derived from the diol compound or X in any of the structural units (A), (B), and (C) is replaced with a different structure.

Furthermore, the proportion of the structural unit (A), and the structural unit (B) and/or (C) (the total amount of the structural units (A) to (C)) in all the structural units constituting the polyester of the embodiment of the present invention is, for example, only required to be 90% by mole or more, and is preferably 93% by mole or more, more preferably 95% by mole or more, and still more preferably 97% by mole or more. It is also preferable that all the structural units included in the polyester of the embodiment of the present invention are composed of the structural units (A), and (B) and/or (C).

The structural units constituting the polyester of the embodiment of the present invention may be bonded randomly or in a block shape. The polyester of the embodiment of the present invention is preferably a random copolymer.

From the viewpoint of the heat resistance and the like of a molded product including the polyester resin of the embodiment of the present invention, the Tg of the polyester of the embodiment of the present invention may be 120° C. or higher, preferably 125° C. or higher, and more preferably 130° C. or higher. An upper limit value thereof is not particularly limited, but is practically 200° C. or lower.

In the present invention, the Tg of the polyester is a value measured by a method described in Examples which will be described later.

A water absorption rate of the polyester of the embodiment of the present invention can be set to less than 0.30% by mass, and is preferably less than 0.28% by mass, and more preferably less than 0.24% by mass. A lower limit value thereof is not particularly limited.

In the present invention, the water absorption rate of the polyester is a water absorption rate measured and calculated by a Karl Fischer vaporization method described in Examples which will be described later.

The polyester of the embodiment of the present invention has low water absorbency and can be suitably used as a low dielectric material.

A dielectric constant of the polyester of the embodiment of the present invention at 25° C. and 10 GHz can be set to less than 2.9, and is preferably less than 2.8, and more preferably less than 2.7. A lower limit value thereof is not particularly limited, but is practically 2.0 or more.

In addition, a dielectric loss tangent of the polyester of the embodiment of the present invention at 25° C. and 10 GHz can be set to less than 0.045, and is preferably less than 0.040, and more preferably less than 0.035. A lower limit value thereof is not particularly limited, but is practically 0.010 or more.

In the present invention, the dielectric constant and the dielectric loss tangent of the polyester at 25° C. and 10 GHz are values measured by a resonance perturbation method described in Examples which will be described later.

From the viewpoint of easily obtaining a molded product with a small thickness having excellent fluidity, and having good moldability, a melt volume-flow rate (MVR) of the polyester of the embodiment of the present invention is usually only required to be 5 ml/10 min or more, and preferably 20 ml/10 min or more. An upper limit value thereof is not particularly limited, but is practically less than 60 ml/10 min.

In the present invention, the MVR of the polyester is a value measured by a method described in Examples which will be described later.

A weight-average molecular weight (Mw) of the polyester of the embodiment of the present invention may be adjusted as appropriate depending on chemical structures and the content proportions of the above-described structural units (A) to (C) in order to exhibit an MVR capable of realizing good moldability. The Mw can be set to, for example, 10,000 to 200,000, and is preferably 20,000 to 150,000, more preferably 30,000 to 120,000, and still more preferably 40,000 to 100,000. The weight-average molecular weight can be adjusted by controlling an equivalent ratio and the like of the dicarboxylic acid compound or the compound having in which a carboxy group is activated, which is reacted with the bisphenol compound.

In the present invention, the weight-average molecular weight of the polyester is a value measured by a method described in Examples which will be described later.

### Synthesis Method

The polyester of the embodiment of the present invention can be produced by a common ordinary method without particular limitation. For example, a polycondensation reaction between a diol compound and a dicarboxylic acid compound, or an ester exchange reaction (ester exchange method) between a diol compound and a compound having two ester structures in the molecule can be employed.

Furthermore, the dicarboxylic acid compound may be a compound in which a carboxy group in the dicarboxylic acid compound is activated, such as a dicarboxylic acid halide compound.

### Diol Compound

In any of the polycondensation reaction and the ester exchange method, at least a bisphenol compound (a) represented by Formula (a), a bisphenol compound (b) represented by Formula (b), and a bisphenol compound (c) represented by Formula (c), which are necessary for synthesizing the above-described structural units (A) to (C), are used as the diol compound.

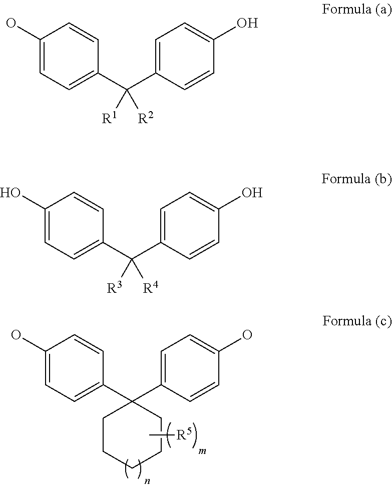

R¹ to R⁵, m, and n in Formulae (a) to (c) correspond to and have the same definitions as R¹ to R⁵, m, and n in Formulae (A) to (C) described above, respectively.

Preferred specific examples of the bisphenol compounds (a) to (c) are described below, but the present invention is not limited to forms in which these compounds are used.

### Bisphenol Compound (a)

Examples of the bisphenol compound (a) in which R¹ is a nonyl group and R² is a hydrogen atom include 1,1-bis(4-hydroxyphenyl) decane, 1,1-bis(3-methyl-4-hydroxyphenyl) decane, 1,1-bis(2,3-dimethyl-4-hydroxyphenyl) decane, 1,1-bis(3,5-dimethyl-4-hydroxyphenyl) decane, 1,1-bis(3-ethyl-4-hydroxyphenyl) decane, 1,1-bis(3-propyl-4-hydroxyphenyl) decane, 1,1-bis(3-butyl-4-hydroxyphenyl) decane, and 1,1-bis(3-nonyl-4-hydroxyphenyl) decane.

Furthermore, compounds in which R¹ and/or R² in the compound is replaced with R¹ and/or R² in General Formula (A) described above can also be included in the specific examples. Bisphenol Compound (b)

Examples of the bisphenol compound (b) in which R³ is a tert-butyl group and R⁴ is a methyl group include 2,2-bis(4-hydroxyphenyl)-4-methylpentane, 2,2-bis(3-methyl-4-hydroxyphenyl)-4-methylpentane, 2,2-bis(2,3-dimethyl-4-hydroxyphenyl)-4-methylpentane, 2,2-bis(3,5-dimethyl-4-hydroxyphenyl)-4-methylpentane, 2,2-bis(3-ethyl-4-hydroxyphenyl)-4-methylpentane, 2,2-bis(3-propyl-4-hydroxyphenyl)-4-methylpentane, 2,2-bis(3-butyl-4-hydroxyphenyl)-4-methylpentane, and 2,2-bis(3-nonyl-4-hydroxyphenyl)-4-methylpentane.

Furthermore, compounds in which R³ and/or R⁴ in the compound is substituted with R³ and/or R⁴ in General Formula (B) described above can also be included in the specific examples. Bisphenol Compound (c)

Examples of the bisphenol compound (c) in which n is 1, m is 3, and R⁵ is a methyl group include 1,1-bis(4-hydroxyphenyl)-3,3,5-trimethylcyclohexane, 1,1-bis(3-methyl-4-hydroxyphenyl)-3,3,5-trimethylcyclohexane, and 1,1-bis(3-phenyl-4-hydroxyphenyl)-3,3,5-trimethylcyclohexane.

Furthermore, compounds in which at least any of n, m, and R⁵ in the compound is replaced with n, m, and R⁵ in General Formula (C) described above can also be included in the specific examples.

### Dicarboxylic Acid Compound and the Like

In the polycondensation reaction, at least a dicarboxylic acid compound represented by Formula (x1), which is necessary for synthesizing X in the above-described structural units (A) to (C), is used as the dicarboxylic acid compound.

HOOC—X—COOH Formula (x1)

X in Formula (x1) corresponds to X in Formulae (A) to (C) and has the same definition as described above.

Examples of the dicarboxylic acid compound represented by Formula (x1) include terephthalic acid, isophthalic acid, phthalic acid, 2,7-naphthalenedicarboxylic acid, 2,6-naphthalenedicarboxylic acid, 1,4-naphthalenedicarboxylic acid, and anthracenedicarboxylic acid.

In addition, a compound in which a carboxy group in the dicarboxylic acid compound represented by Formula (x1) is activated, such as a dicarboxylic acid halide compound (preferably a dicarboxylic acid chloride compound), can also be preferably used.

### Compound Having Two Ester Structures in Molecule

In the ester exchange reaction, at least a compound represented by Formula (x2), which is necessary for synthesizing X in the above-described structural units (A) to (C), is used as the compound having two ester structures in the molecule.

ROC(═O)—X—C(═O)OR Formula (x2)

X in Formula (x2) corresponds to X in Formulae (A) to (C) described above, and has the same definition. R represents an alkyl group, and is preferably methyl or ethyl.

Examples of the compound represented by Formula (x2) include dimethyl terephthalate and dimethyl isophthalate.

In a case where the polyester of the embodiment of the present invention contains a structural unit (other structural unit) other than the above-described structural units (A), (B), and (C), the polyester can be produced by using a diol compound corresponding to the other structural unit in addition to the bisphenol compounds (a) to (c), or by using a dicarboxylic acid compound or a compound having two ester structures in the molecule corresponding to the other structural unit in addition to the dicarboxylic acid compound represented by Formula (x1) or the compound in which a carboxy group is activated, or the compound represented by Formula (x2).

Specific examples of other structural units include a bisphenol compound, which is different from any of the bisphenol compounds (a), (b), and (c), among the aromatic diols (bisphenol compounds) described in paragraph and the like of JP2003-29447A, the aliphatic dihydroxy compound (diol compound) described in paragraph of JP2003-29447A, and a dicarboxylic acid compound such as fumaric acid, malonic acid, succinic acid, glutaric acid, adipic acid, or maleic acid, or a compound in which a carboxy group is activated.

As a method of producing the polyester of the embodiment of the present invention, a commonly used polymerization method can be used, and examples of the method include an interfacial polymerization method, a melt polymerization method, and a solution polymerization method

### Additive

The polyester resin of the embodiment of the present invention may have a form in which an additive is blended with the polyester of the embodiment of the present invention.

As the additive, an additive commonly used as an additive to a polyester resin can be used within a range where the effects of the present invention are not impaired. For example, depending on various uses, a flame retardant, a mold release agent, an ultraviolet absorber, a dye, a pigment, a fluorescent brightening agent, a dropping preventing agent, an antistatic agent, a heat stabilizer, an antioxidant, an antifogging agent, a lubricant, an antiblocking agent, a dispersant, an antibacterial agent, or the like can be used.

### Uses

The polyester resin of the embodiment of the present invention can be used without particular limitation in uses where a polyester resin is used, and examples thereof include an electronic device housing, a metal wire coating film, and a polarizing plate protective film for a display device.

Since the polyester resin of the embodiment of the present invention is excellent in achieving both a high Tg and low water absorbency, it can be suitably used as a low-dielectric material, for which a low dielectric constant and a low dielectric loss tangent are required.

### Molded Product

The molded product of the embodiment of the present invention includes the polyester resin of the embodiment of the present invention.

A molding method using the polyester resin of the embodiment of the present invention is not particularly limited, and in addition to a molding method used for a thermoplastic resin, such as injection molding, extrusion molding, vacuum molding, and blow molding, a thermal fusion laminating method in which a representative resin in a method for manufacturing a 3D printer is melted and laminated can also be applied.

Furthermore, the polyester resin of the embodiment of the present invention is suitably used for molding a thin optical part since it can realize achieving both a high Tg and low water absorbency even in a case where it has an MVR (usually 5 ml/10 min or more (preferably 20 ml/10 min or more) and less than 60 ml/10 min) capable of obtaining good moldability. Specifically, a pellet obtained by pelletizing the polyester resin of the embodiment of the present invention can be molded by various molding methods to produce a thin optical part, and is particularly suitably used for molding a thin optical part by an injection molding method.

With regard to the definition of and the forming method for the thin optical part, reference can be made to the description in to of WO2017/099226A, except that the “polycarbonate resin composition” is replaced with the “polyester resin of the embodiment of the present invention”.

### Examples

Hereinafter, the present invention will be described in more detail with reference to Examples. The materials, the amounts of materials used, the proportions, the treatment details, the treatment procedure, and the like shown in Examples below can be appropriately modified as long as the modifications do not depart from the spirit of the present invention. Therefore, the scope of the present invention should not be construed as being limited to the following specific examples.

### Synthesis Example of Polyester

### (1) Synthesis of Polyester 5

7.62 g of 4-[1-(4-hydroxyphenyl)-1,3-dimethyl-butyl]phenol, 3.94 g of 4,4′-(decan-1,1-diyl)diphenol, 0.045 g of t-butylphenol, 100 ml of dehydrated dichloromethane, and 10.76 g of diisopropylethylamine were added to a 500 ml separable flask, and the mixture was cooled to 5° C. with ice water while passing a nitrogen flow therethrough. After the contents were dissolved and made uniform, a solution obtained by dissolving 4.10 g of terephthalic acid dichloride and 4.10 g of isophthalic acid dichloride in 20 ml of dichloromethane was added dropwise thereto while keeping the internal temperature at 5° C. to 15° C. After the completion of the dropwise addition, the mixture was stirred at 10° C. to 15° C. for 30 minutes and then stirred at room temperature (25° C.) for 3 hours. The reaction solution was added dropwise to methanol to obtain a powder, and then filtration drying was performed to obtain a polyester 5. The dry yield was 12.1 g (yield of 86%), the weight-average molecular weight was 58,000, and the MVR was 10 ml/10 min.

### (2) Synthesis of Polyesters 1 to 4, 6 to 12, and c1 to c3

Polyesters 1 to 4, 6 to 12, and c1 to c3 were obtained in the same manner as in the synthesis of the polyester 5, except that the bisphenol component was changed to the bisphenol component shown in Table 1 below. Furthermore, each of the polyesters was prepared and synthesized so that the MVR of the polyester was a value in a range of 5 ml/10 min or more and less than 30 ml/10 min, which exhibited good moldability, and the weight-average molecular weight was a value in a range of 30,000 to 100,000.

Furthermore, the MVR was measured by an isothermal method under the following conditions, using a flow tester CFT-500D (product name, manufactured by Shimadzu Corporation) for a dried sample of the synthesized polyester.

### Measurement Conditions

Measurement temperature: 300° C.
Retained heat time: 300 seconds
Test force: 6 Kgf/cm²
Die hole diameter: φ 1 mm

In addition, the weight-average molecular weight (Mw) of the synthesized polyester refers to a weight-average molecular weight in terms of polystyrene, which is measured by gel permeation chromatography (GPC).

### Measurement Condition 1

Measuring instrument: TOSOH EcoSEC HLC-8320GPC (product name, manufactured by Tosoh Corporation)
Column: Connection of TOSOH TSKgel Super HZM-H (product name, manufactured by Tosoh Corporation), TOSOH TSKgel Super HZ4000 (product name, manufactured by Tosoh Corporation), and TOSOH TSKgel Super HZ2000 (product name, manufactured by Tosoh Corporation)
Carrier: Tetrahydrofuran (containing a BHT stabilizer) (manufactured by FUJIFILM Wako Pure Chemical Corporation)
Measurement temperature: 40° C.
Carrier flow rate: 0.35 ml/min
Sample concentration: 0.05% by mass
Detector: Refractive index (RI) detector, UV detector (254 nm)

Polyesters 1 to 12 are the polyesters of the embodiment of the present invention, and polyesters c1 to c3 are comparative polyesters.

### Evaluation

The obtained polyesters were subjected to the following measurement and evaluation. The results are summarized in Table 1 below.

### Evaluation 1: Evaluation of Water Absorbency

A uniform film with a thickness of about 0.5 mm was manufactured by hot pressing (at about 240° C. to 280° C.), and about 0.2 g of the manufactured film was cut out and infused in ion exchange water. After infusing the film at 25° C. for one week to prepare a saturated water-containing sample, water droplets on the surface were wiped off, the sample was subjected to a measurement by a Karl Fischer vaporization method (measurement device: AQ-2250 (product name, manufactured by Kitahama Corporation), vaporization device: AQS-225320 (product name, manufactured by Hiranuma Co., Ltd.), reagent used: AQUALITE RS-A (for general use, product name, manufactured by Hiranuma Co., Ltd.), measurement temperature: 180° C., nitrogen gas flow rate: 200 ml/min), and the water absorption rate was calculated from the following expression to evaluate the water absorbency.

Water absorption rate (% by mass)=100%×(C−D)/E

C means the amount of water measured in the saturated moisture-containing sample, D means the amount of water measured in the Blank, and E means the sampling amount of the saturated moisture-containing sample used for the measurement.

### Evaluation 2: Evaluation of Glass Transition Temperature (Tg)

As the glass transition temperature (Tg), the glass transition temperature described in POLYMER HANDBOOK 4th, Chapter 36 was adopted. In a case where the glass transition temperature is not described in the reference, the glass transition temperature is a value measured under the following measurement conditions. The Tg was evaluated according to the following standard.

### Measurement of Tg

The glass transition temperature (Tg) was measured under the following measurement conditions for a dried sample of the polyester using a differential scanning calorimeter: X-DSC7000 (product name, manufactured by SII NanoTechnology Inc.). Tg was measured twice for the same sample, and the secondly measured Tg was adopted.

### Measurement Conditions

Atmosphere in measurement chamber: Nitrogen gas (50 ml/min)
Temperature rising rate: 5° C./min
Measurement start temperature: −80° C.
Measurement end temperature: 250° C.
Specimen pan: Aluminum pan
Mass of measurement sample: 5 mg.
   Calculation of Tg: Tg was calculated by rounding off the decimal point in the intermediate temperature between the descent start point and the descent end point of the differential scanning calorimetry (DSC) chart.

### Evaluation 3: Evaluation of Dielectric Constant and Dielectric Loss Tangent

The dielectric loss tangent was measured by a resonance perturbation method at a frequency of 10 GHz. A 10 GHz cavity resonator (manufactured by Kanto Electronic Application Development Inc., product name: CP531) was connected to a network analyzer (manufactured by Agilent Technology, Inc., product name: E8363B), and a film-like test piece cut out from the uniform film manufactured in Evaluation 1 above was inserted into the cavity resonator, and the film-like test piece was left to stand in an environment of a temperature of 25° C. and an RH of 60% for 96 hours. The dielectric constant and the dielectric loss tangent of the film were measured from a change in resonance frequency between before inserting the test piece and after inserting the test piece and then leaving it to stand for 96 hours, and evaluated by applying the following standard.

### Evaluation Standard (Dielectric Constant)

5: Dielectric constant of 2.0 or more and less than 2.7
4: Dielectric constant of 2.7 or more and less than 2.8
3: Dielectric constant of 2.8 or more and less than 2.9
2: Dielectric constant of 2.9 or more and less than 3.0
1: Dielectric constant of 3.0 or more
   Evaluation Standard (Dielectric loss Tangent)
5: Dielectric loss tangent of 0.010 or more and less than 0.035
4: Dielectric loss tangent of 0.035 or more and less than 0.040
3: Dielectric loss tangent of 0.040 or more and less than 0.045
2: Dielectric loss tangent of 0.045 or more and less than 0.050
1: Dielectric loss tangent of 0.050 or more

TABLE 1

| | Bisphenol component | | | | | | Dicarboxylic acid component | | | | Evaluation | | | |
|---|---|---|---|---|---|---|---|---|---|---|---|---|---|---|
| | Compound (a) | | Compound (b) | | Compound (c) | | X component | | | | | Water | | Dielec- |
| | Monomer | | Monomer | | Monomer | | Monomer | | Monomer | | | absorp- | Dielec- | tric |
| | compo- | Molar | compo- | Molar | compo- | Molar | compo- | Molar | compo- | Molar | | tion | tric | loss |
| No. | nent | ratio | nent | rate | nent | ratio | nent | ratio | nent | ratio | Tg | rate | constant | tangent |
| 1 | A-1 | 30 | B-1 | 70 | — | — | X-1 | 50 | X-2 | 50 | 151 | 0.25 | 3 | 3 |
| 2 | A-2 | 30 | B-1 | 70 | — | — | X-1 | 50 | X-2 | 50 | 141 | 0.23 | 4 | 4 |
| 3 | A-3 | 30 | B-1 | 70 | — | — | X-1 | 50 | X-2 | 50 | 130 | 0.18 | 5 | 5 |
| 4 | A-4 | 30 | B-1 | 70 | — | — | X-1 | 50 | X-2 | 50 | 145 | 0.23 | 4 | 4 |
| 5 | A-2 | 30 | B-2 | 70 | — | — | X-1 | 50 | X-2 | 50 | 136 | 0.19 | 5 | 5 |
| 6 | A-2 | 30 | B-3 | 70 | — | — | X-1 | 50 | X-2 | 50 | 125 | 0.21 | 5 | 5 |
| 7 | A-2 | 50 | — | — | C-1 | | X-1 | 50 | X-2 | 50 | 151 | 0.28 | 3 | 3 |
| 8 | A-2 | 50 | — | — | C-2 | 50 | X-1 | 50 | X-2 | 50 | 155 | 0.25 | 3 | 3 |
| 9 | A-2 | 20 | B-2 | 80 | — | — | X-1 | 50 | X-2 | 50 | 151 | 0.21 | 5 | 5 |
| 10 | A-2 | 40 | B-2 | 60 | — | — | X-1 | 50 | X-2 | 50 | 127 | 0.18 | 5 | 5 |
| 11 | A-2 | 50 | B-2 | 50 | — | — | X-1 | 50 | X-2 | 50 | 121 | 0.17 | 5 | 5 |
| 12 | A-2 | 30 | B-2 | 35 | C-2 | 35 | X-1 | 50 | X-2 | 50 | 148 | 0.24 | 4 | 4 |
| c1 | A-2 | 100 | — | — | — | — | X-1 | 50 | X-2 | 50 | 70 | 0.16 | 5 | 5 |
| c2 | — | — | B-2 | 100 | — | — | X-1 | 50 | X-2 | 50 | 187 | 0.35 | 2 | 2 |
| c3 | — | — | — | — | C-2 | 100 | X-1 | 50 | X-2 | 50 | 230 | 0.55 | 1 | 1 |

### Notes in Table

Nos. 1 to 12 and c1 to c3 mean polyesters 1 to 12 of the embodiment of the present invention, and comparative polyesters c1 to c3, respectively.

Each of the monomer components is as follows.

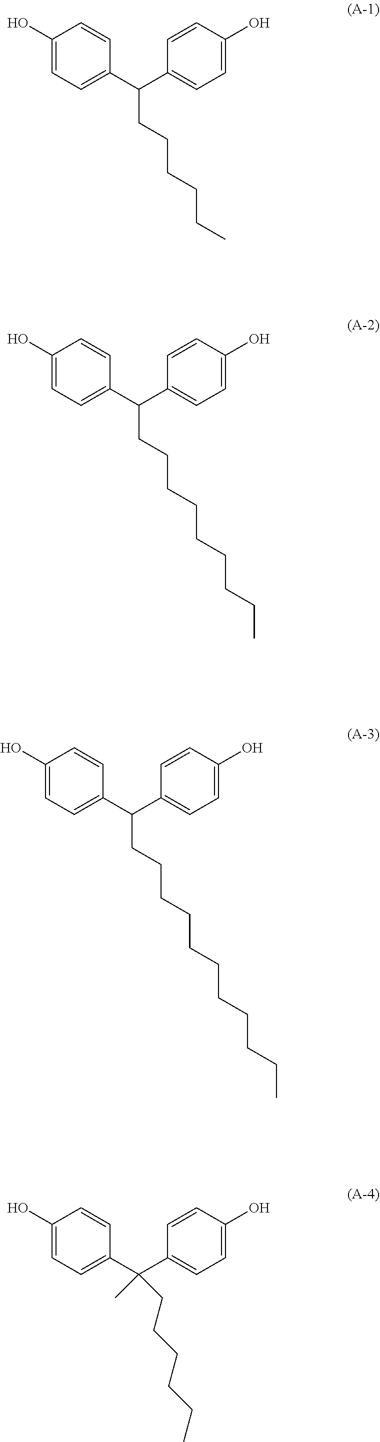 [SMILES: CCCCCCC(c1ccc(O)cc1)c1ccc(O)cc1 ; CCCCCCCCCC(c1ccc(O)cc1)c1ccc(O)cc1 ; CCCCCCCCCCCC(c1ccc(O)cc1)c1ccc(O)cc1 ; CCCCCCC(C)(c1ccc(O)cc1)c1ccc(O)cc1]

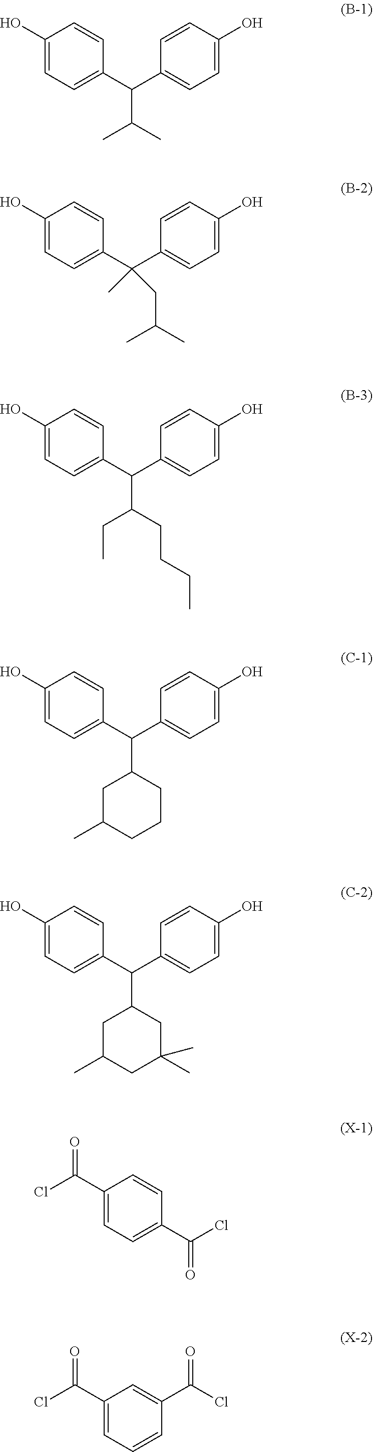

The polyesters 1 to 12 and c1 to c3 are polyesters containing a structural unit derived from a bisphenol component and a structural unit derived from a dicarboxylic acid component at a molar ratio of 1:1.

In the column of the monomer component of the compounds (a) to (c) of the bisphenol component, the bisphenol component constituting the structural unit derived from the bisphenol component (the structural unit other than the structural unit represented by —C(—O)—X—C(═O)— in each of the general formulae) in the structural units represented by General Formulae (A) to (C) is described.

In the column of the monomer component of the X component of the dicarboxylic acid component (dicarboxylic acid chloride component), the dicarboxylic acid components constituting the structural unit derived from the dicarboxylic acid component (structural unit (—C(═O)—X—C(═O)—)) in the structural units represented by General Formulae (A) to (C) is described.

The molar ratio of the compounds (a) to (c) of the bisphenol component means a proportion of each structural unit derived from the bisphenol component in a total of 100% by mole of the structural units derived from the bisphenol component constituting the polyester. That is, the molar ratio corresponds to a proportion of the structural unit represented by each of General Formulae (A) to (C) in the total of 100% by mole of the structural units represented by General Formulae (A) to (C) constituting the polyester. The unit is % by mole.

The molar ratio of X-1 and X-2 of the dicarboxylic acid component means a proportion of a structural unit derived from each dicarboxylic acid component to a total of 100% by mole of the structural units derived from the dicarboxylic acid component constituting the polyester. The unit is % by mole.

“-” indicates that the structural unit does not contain the corresponding structural unit.

Tg represents a glass transition temperature and the unit is ° C.

The unit of the water absorption rate is % by mass.

From Table 1, the following results can be seen.

The glass transition temperature of the comparative polyester c1 consisting of the structural unit represented by General Formula (A) was as low as 70° C. In addition, the water absorption rate of the comparative polyester c2 consisting of the structural unit represented by General Formula (B) was as high as 0.35% by mass, and the water absorption rate of the comparative polyester c3 consisting of the structural unit represented by General Formula (C) was as high as 0.55% by mass.

To the contrary, the polyesters 1 to 12 of the embodiment of the present invention, which contain the structural unit represented by General Formula (A) and at least one of the structural unit represented by General Formula (B) or the structural unit represented by General Formula (C)), realized achieving both a high Tg of 120° C. or higher and low water absorbency with a low water absorption rate of less than 0.30% by mass. In particular, it was found that the water absorption rates (actually measured values) exhibited by the polyesters 5, and 8 to 12 of the embodiment of the present invention are significantly lower than the water absorption rate (calculated value) that is calculated as a product by multiplying the water absorption rate of each of the comparative polyesters c1 to c3 by the content ratio (molar ratio×0.01) of the structural unit in the polyesters 5, and 8 to 12, and indicate low water absorbency which is lower than the water absorption rate simply predicted from the structural unit, and thus, it is possible to realize a sufficiently low water absorbency while maintaining the Tg as the polyester at a high level. For example, in the polyester 11 of the embodiment of the present invention, a content ratio of the structural unit derived from the bisphenol component (A-2), which is the structural unit represented by General Formula (A), to the structural unit derived from the bisphenol component (B-2), which is the structural unit represented by General Formula (B), is 50:50 in terms of a molar ratio. The water absorption rate (calculated value) of the polyester 11 of the embodiment of the present invention obtained using this content ratio is 0.16% by mass×50× 0.01+0.35% by mass×50×0.01=0.26% by mass, while the measured value is 0.17% by mass. Thus, it is possible to achieve a lower water absorption rate.

What is claimed is:

1. A polyester resin comprising:
a structural unit represented by General Formula (A); and
at least one of a structural unit represented by General Formula (B) or a structural unit represented by General Formula (C),
wherein a 1,4-phenylene group in General Formulae (A) to (C) may have an aliphatic hydrocarbon group and/or an aromatic hydrocarbon group as a substituent, 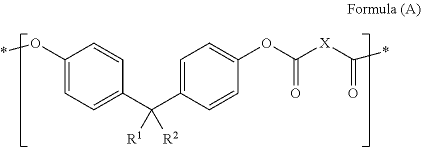
in the formula, R¹ represents a linear aliphatic hydrocarbon group having 6 or more carbon atoms, and R² represents a hydrogen atom, an aliphatic hydrocarbon group, or an aromatic hydrocarbon group, provided that R¹ and R² are not bonded to each other to form a ring,
X represents a hydrocarbon group having a cyclic structure, and
* represents a bonding site, 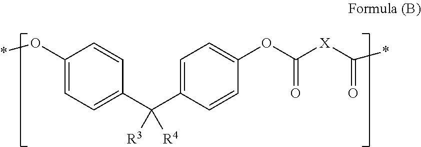
in the formula, R³ represents a branched alkyl group having 3 or more carbon atoms, and R⁴ represents a hydrogen atom or an aliphatic hydrocarbon group having 1 to 5 carbon atoms, provided that R³ and R⁴ are not bonded to each other to form a ring,
X represents a hydrocarbon group having a cyclic structure, and
* represents a bonding site, 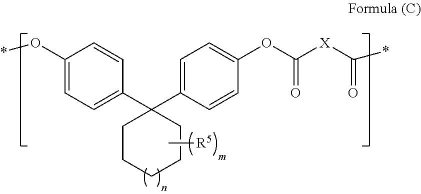
in the formula, R⁵ represents an aliphatic hydrocarbon group, X represents a hydrocarbon group having a cyclic structure,
n is an integer of 0 to 8, m is an integer of 1 to 4, and
* represents a bonding site.

2. The polyester resin according to claim 1,
wherein X is an arylene group.

3. The polyester resin according to claim 1,
wherein the polyester resin contains at least the structural unit represented by General Formula (A) and the structural unit represented by General Formula (B).

4. A molded product comprising:
the polyester resin according to claim 1.
